(19) United States
(12) Patent Application Publication
(10) Pub. No.: US 2025/0121604 A1
(43) Pub. Date: Apr. 17, 2025

(54) LIQUID CONTAINER

(71) Applicant: SEIKO EPSON CORPORATION, Tokyo (JP)

(72) Inventors: Tadahiro Mizutani, Shiojiri-shi (JP); Tadashi Watanabe, Matsumoto-shi (JP); Yuta Koike, Matsumoto-shi (JP); Takumi Nagashima, Matsumoto-shi (JP)

(73) Assignee: SEIKO EPSON CORPORATION, Tokyo (JP)

(21) Appl. No.: 18/917,108

(22) Filed: Oct. 16, 2024

(30) Foreign Application Priority Data
Oct. 17, 2023 (JP) 2023-178714
Jan. 22, 2024 (JP) 2024-007456

(51) Int. Cl. B41J 2/175

(52) U.S. Cl. CPC B41J 2/17553; B41J 2/17509; B41J 2/1755

(57) ABSTRACT

A liquid container that supplies a liquid to a printer includes: a main portion that has openings and is configured to contain the liquid; and a cap member that is detachably attached to the main portion and closes the openings in an openable and closable manner, in which the cap member is made of a material that contains a recycled material.

The present application is based on, and claims priority from JP Application Serial Number 2023-178714, filed Oct. 17, 2023 and JP Application Serial Number 2024-007456, filed Jan. 22, 2024, the disclosures of which are hereby incorporated by reference herein in their entirety.

### BACKGROUND

### 1. Technical Field

The present disclosure relates to a liquid container.

### 2. Related Art

Hitherto, a liquid container including a main portion that can contain ink has been known. The main portion of the liquid container in Japanese Patent No. 7247606 has two openings, and a spout having an ink outlet and a cap covering the ink outlet are attached to one of the openings. The other opening is sealed with a film and further covered with a cover member. A main portion of a liquid container in JP-A-2022-129862 is made of reusable metal. Further, in the liquid container in JP-A-2022-129862, a spout having an ink outlet and a cap covering the ink outlet are attached to an opening of the main portion.

The liquid container in Japanese Patent No. 7247606 is difficult to reuse because the spout and cap are easily damaged or broken during transportation, which can cause a problem of environmental load. The liquid container in JP-A-2022-129862 can cause a problem in that it is difficult to form the main portion by using metal when the spout or cap has a complex shape. For this reason, there is a demand for providing a liquid container that can contribute to reducing an environmental load.

### SUMMARY

The present disclosure can be implemented in the following aspects. According to an aspect of the present disclosure, a liquid container that supplies a liquid to a printer is provided. The liquid container includes: a main portion that has openings and is configured to contain the liquid, and a cap member that is detachably attached to the main portion and closes the openings in an openable and closable manner, in which the cap member is made of a material that contains a recycled material.

### BRIEF DESCRIPTION OF THE DRAWINGS

FIG. 1 is a perspective view of a printer in a first embodiment.

FIG. 2 is a perspective view illustrating a state in which a liquid container is used to supply ink to an ink tank.

FIG. 3 is a cross-sectional view of the liquid container in the first embodiment.

FIG. 4 is an enlarged view of a front end side of the liquid container.

FIG. 5 is an enlarged view of a rear end side of the liquid container.

FIG. 6 is an exploded perspective view of the liquid container in the first embodiment.

FIG. 7 is a perspective view of an outlet valve unit.

FIG. 8 is a perspective view illustrating a state in which a flow path member is inserted into the outlet valve unit.

FIG. 9 is a view illustrating a configuration of a liquid container in a second embodiment.

FIG. 10 is a view illustrating a configuration of a liquid container in a third embodiment.

### DESCRIPTION OF EMBODIMENTS

### A. First Embodiment

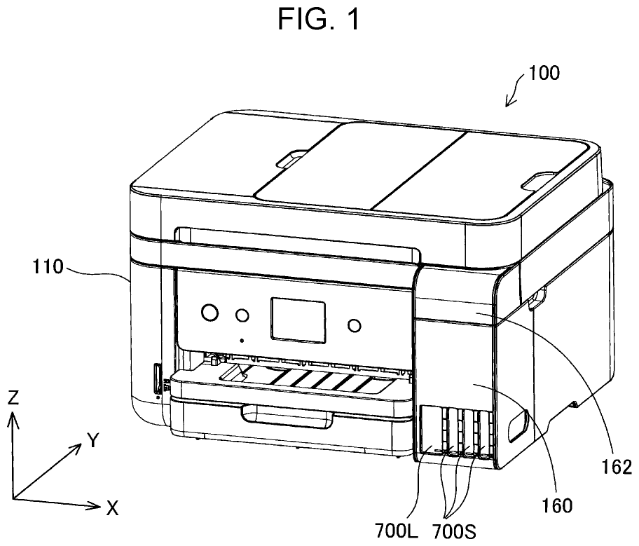

FIG. 1 is a perspective view of a printer in a first embodiment. A printer 100 is an ink jet printer that performs printing by ejecting ink onto a print medium. An X axis, a Y axis, and a Z axis orthogonal to each other are depicted in FIG. 1. The X axis corresponds to a width direction of the printer 100, the Y axis corresponds to a depth direction of the printer 100, and the Z axis corresponds to a height direction of the printer 100. The printer 100 is installed on a horizontal installation surface defined by an X-axis direction and a Y-axis direction. Note that the “X-axis direction” refers to a combination of a +X direction and a −X direction. Similarly, the “Y-axis direction” refers to a combination of a +Y direction and a −Y direction, and a “Z-axis direction” refers to a combination of a +Z direction and a −Z direction.

The printer 100 includes a housing 110. A carriage (not illustrated) that is movable in a main scanning direction that is the X-axis direction is provided inside the housing 110. A print head that ejects the ink onto the print medium is installed on the carriage. An ink tank housing unit 160 that houses a plurality of ink tanks 700S and 700L is provided at one end of a front surface of the housing 110. The ink tank housing unit 160 includes an openable and closable cover 162 provided at an upper portion of the ink tank housing unit 160. The ink tank 700S is a small capacity tank, and the ink tank 700L is a large capacity tank. However, in the following description, the ink tank 700S and the ink tank 700L will be simply referred to as an “ink tank 700” without distinguishing between them. Each ink tank 700 is coupled to the print head of the carriage by a tube (not illustrated). That is, the ink tank 700 is a stationary ink tank that is not mounted on the carriage of the printer 100. Furthermore, each ink tank 700 is an ink replenishment type ink tank that is replenished with the ink from a liquid container when an ink level decreases. Although the ink tank 700 is a stationary ink tank in the present embodiment, the ink tank 700 may also be an ink tank mounted on the carriage of the printer 100.

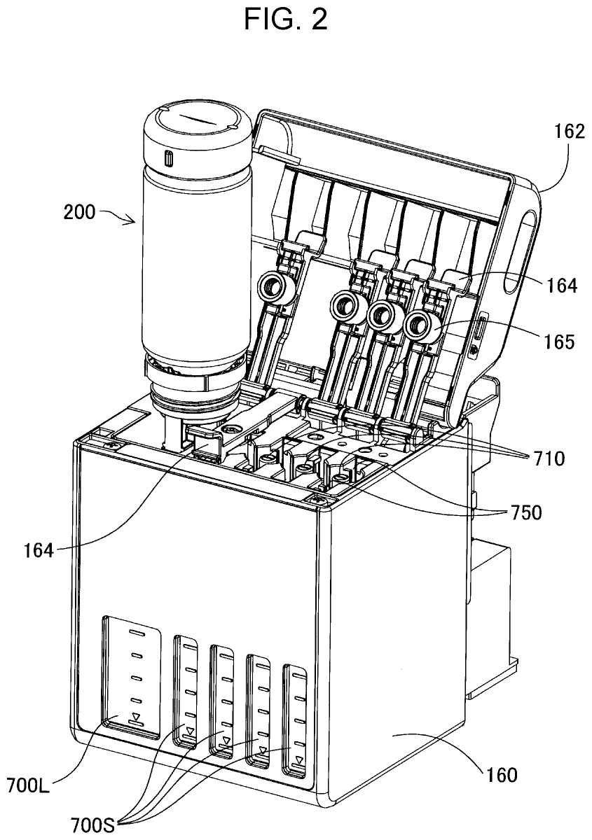

FIG. 2 is a perspective view illustrating a state in which a liquid container 200 is used to supply the ink to the ink tank 700. A front surface of each ink tank 700 is made of a transparent material, and the ink level in each ink tank 700 can be visually checked from the outside. When the ink level is low, it is possible to open the cover 162 and replenish the ink through a flow path member 710 of the ink tank 700.

The tubular flow path member 710 that communicates with the ink tank 700 is provided on an upper surface of each ink tank 700. The ink tank housing unit 160 includes a sealing cap member 164. The sealing cap member 164 includes a sealing cap 165 for sealing a tip of the flow path member 710. When the ink tank 700 is not replenished with ink, the tip of the flow path member 710 is sealed with the sealing cap 165 of the sealing cap member 164. When replenishing the ink in the ink tank 700, the sealing cap member 164 is removed from the flow path member 710, and a front end of the liquid container 200 is inserted at a position at which the flow path member 710 is provided to replenish the ink. Two recesses 750 into which wall portions of the liquid container 200 described below are fitted are provided around the flow path member 710. The recesses 750 have a shape that is rotationally symmetric 180 degrees around the flow path member 710.

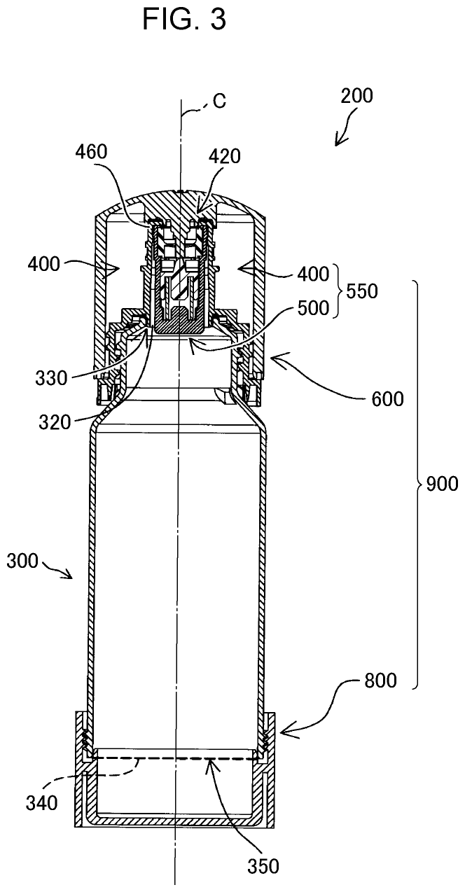

FIG. 3 is a cross-sectional view of the liquid container 200 in the first embodiment. The liquid container 200 includes a main portion 300 and a cap member 900. The main portion 300 is configured to be able to contain a liquid. In the present embodiment, the main portion 300 is a hollow container having a cylindrical shape. The main portion 300 has two openings 320 and 340 formed at an upper portion and a bottom portion of the cylindrical shape. The two openings include a first opening 320 for supplying the liquid to the printer 100, and a second opening 340 disposed at a position different from the first opening 320. In the present embodiment, the first opening 320 is formed at an upper portion 330 of the main portion 300. The second opening 340 is formed at a bottom portion 350 of the main portion 300. The liquid container 200 does not have to have two openings, the first opening 320 and the second opening 340. For example, it is sufficient if the liquid container 200 has only the first opening 320.

In the present embodiment, the cap member 900 includes an outlet member 550, a first cap member 600, and a second cap member 800. The outlet member 550 includes a liquid outlet forming portion 400 and an outlet valve unit 500. The liquid outlet forming portion 400 includes a tube portion 420 that forms a liquid outlet portion 460. The liquid outlet portion 460 is a liquid outlet for supplying the liquid flowing from the first opening 320 to the printer 100. The outlet valve unit 500 is mounted inside the tube portion 420. Therefore, the outlet valve unit 500 can be considered as a member that forms a part of the liquid outlet forming portion 400. The liquid outlet forming portion 400 and the outlet valve unit 500 are described in detail below. Further, the cap member 900 does not have to include all of the outlet member 550, the first cap member 600, and the second cap member 800, and it is sufficient if the cap member 900 includes at least one of the outlet member 550, the first cap member 600, or the second cap member 800.

In the present embodiment, the first cap member 600 is a cap, and the second cap member 800 is a bottom cap. The first cap member 600 is detachably attached to the main portion 300 via the liquid outlet forming portion 400, and closes the first opening 320 in an openable and closable manner. In the present embodiment, the first cap member 600 has a shape covering the liquid outlet portion 460 of the outlet member 550. The second cap member 800 is detachably attached to the main portion 300, and closes the second opening 340 in an openable and closable manner.

In FIG. 3, a central axis C of the liquid container 200 is illustrated. In the present disclosure, a direction parallel to the central axis C of the liquid container 200 is called an “axial direction”, and a direction orthogonal to the central axis C is called a “radial direction”. An upper end side of the liquid container 200, which is a first cap member 600 side, is called a “front end side”, and a lower end side of the liquid container 200, which is a second cap member 800 side, is called a “rear end side”.

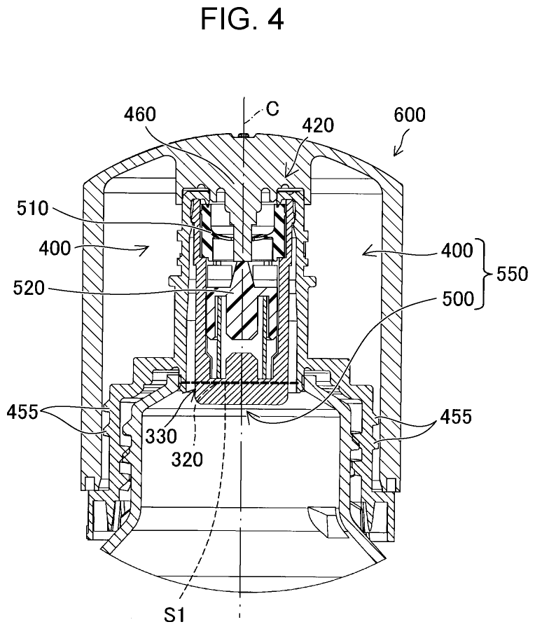

FIG. 4 is an enlarged view of the front end side of the liquid container 200 in FIG. 3. The outlet valve unit 500 included in the outlet member 550 includes a valve body 520. Further, the outlet valve unit 500 includes a sealing member 510 provided on a front end side of the valve body 520. The valve body 520 and the sealing member 510 are described in detail below. In the present embodiment, a female thread portion (not illustrated) is formed on an inner circumference of the first cap member 600 at an end portion on a rear end side of the first cap member 600. The female thread portion of the first cap member 600 is threadably engaged with a first male thread portion 455 formed on an outer circumferential surface of the liquid outlet forming portion 400. Therefore, the first cap member 600 can be attached and detached to and from the liquid outlet forming portion 400.

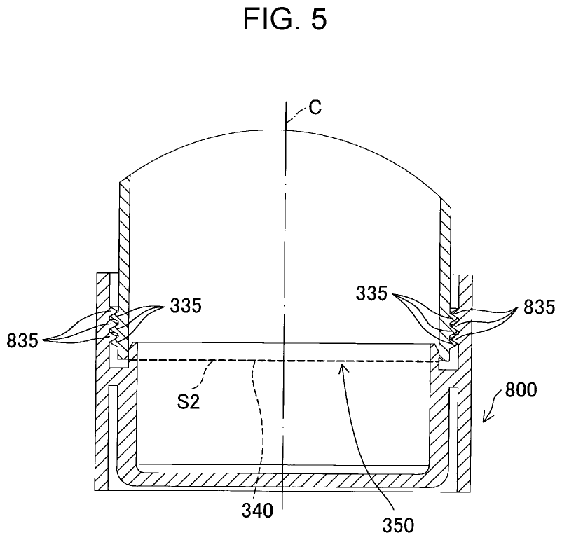

FIG. 5 is an enlarged view of the rear end side of the liquid container 200 in FIG. 3. A second male thread portion 335 is formed on an outer circumferential surface of the main portion 300 on a rear end side. Meanwhile, a second female thread portion 835 is formed on an inner circumferential surface of the second cap member 800 on a front end side. Therefore, the second cap member 800 can be attached and detached to and from the main portion 300.

In the present embodiment, the liquid container 200 has two openings, the first opening 320 and the second opening 340, as illustrated in FIG. 3. Therefore, it is possible to efficiently store the liquid in the main portion 300 by using the second opening 340 or both the first opening 320 and the second opening 340. Furthermore, it is possible to efficiently discharge the residual liquid in the main portion 300 and to efficiently clean and dry the main portion 300 by using the second opening 340 or both the first opening 320 and the second opening 340.

In the present embodiment, an opening area S2 of the second opening 340 illustrated in FIG. 5 is larger than an opening area S1 of the first opening 320 illustrated in FIG. 4. The opening area S1 is an opening area of the upper portion 330 of the main portion 300 when the liquid container 200 is viewed in a direction along the central axis C from the front end side. The opening area S2 is an opening area of the bottom portion 350 of the main portion 300 when the liquid container 200 is viewed in the direction along the central axis C from the rear end side. According to the aspect, by making the opening area S2 of the second opening 340 larger than the opening area S1 of the first opening 320, it is possible to increase efficiency when storing the liquid in the main portion 300 and when cleaning the inside of the main portion 300 by mainly using the second opening 340.

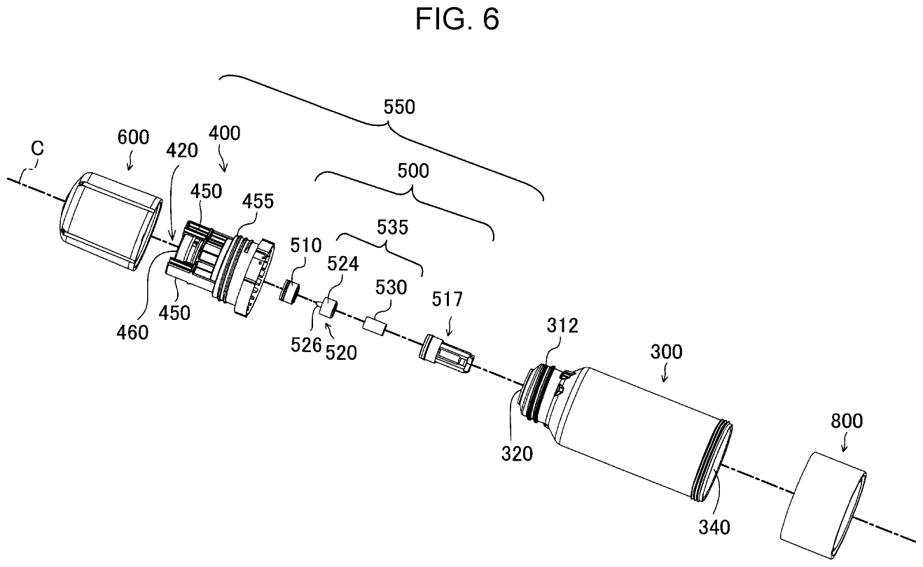

FIG. 6 is an exploded perspective view of the liquid container 200 in the first embodiment. As described above, the liquid container 200 includes the main portion 300, the liquid outlet forming portion 400, the first cap member 600, and the second cap member 800. The liquid outlet forming portion 400 includes the outlet valve unit 500 provided therein. The liquid outlet portion 460 is provided at a front end of the liquid outlet forming portion 400. As described above, the liquid outlet forming portion 400 includes the first male thread portion 455 formed on the outer circumferential surface of the liquid outlet forming portion 400.

The liquid outlet portion 460 has a tubular shape, and two protruding wall portions 450 that extend in the axial direction are provided in a region outside the liquid outlet portion 460 in the radial direction. In the present embodiment, the two wall portions 450 have a shape that is rotationally symmetric 180 degrees around the central axis C of the liquid container 200. The wall portions 450 are fitted into the recesses 750 provided around the flow path member 710 of the ink tank 700 illustrated in FIG. 2. Further, the wall portions 450 can be configured such that, for example, the wall portions 450 of the liquid container 200 for replenishing yellow ink are fitted into the recesses 750 corresponding to the ink tank 700 containing yellow ink, and the wall portions 450 of the liquid container 200 for replenishing other colors of ink such as magenta ink or cyan ink cannot be fitted into the recesses 750 corresponding to the ink tank 700 containing yellow ink. Since FIGS. 3 and 4 are cross-sectional views that do not include the wall portions 450, the liquid outlet forming portion 400 does not include the wall portions 450.

The outlet valve unit 500 illustrated in FIG. 6 is configured to seal the liquid outlet portion 460 to prevent the ink from leaking to the outside in a non-replenishment state in which the ink tank 700 is not replenished with ink, and is configured to be opened when the flow path member 710 is inserted into the liquid outlet portion 460 such that the ink flows into the flow path member 710 in a replenishment state in which the ink tank 700 is replenished with ink.

The outlet valve unit 500 includes a valve housing 517, the sealing member 510, and a spring valve 535. The valve housing 517 is mounted inside the tube portion 420 so as to form a gap in the radial direction between the tube portion 420 and the valve housing 517.

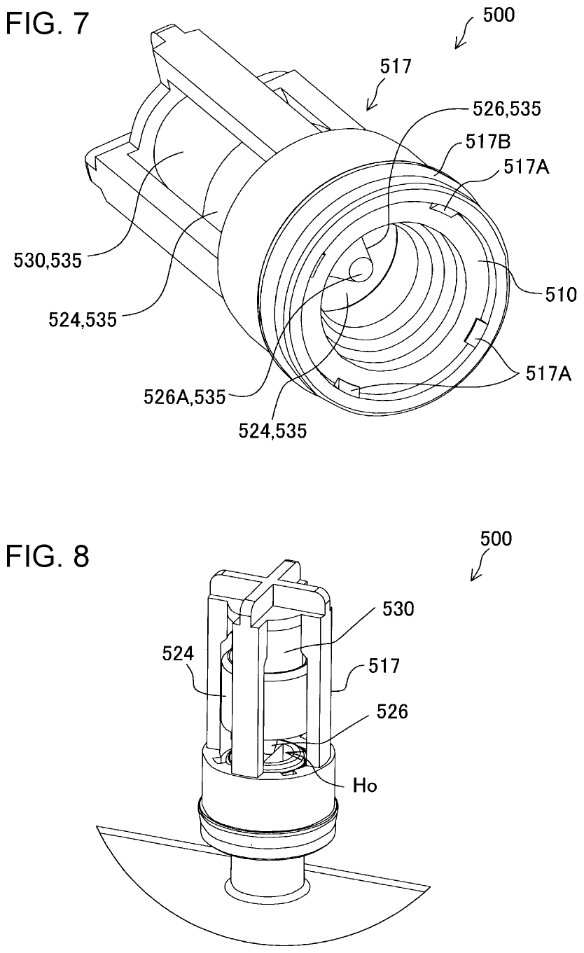

FIG. 7 is a perspective view of the outlet valve unit 500. FIG. 8 is a perspective view illustrating a state in which the flow path member 710 is inserted into the outlet valve unit 500.

The flow path member 710 illustrated in FIG. 2 can be inserted into and removed from the valve housing 517. As illustrated in FIG. 7, the valve housing 517 includes a retaining portion 517A for the sealing member 510 and an engagement portion 517B for the tube portion 420 at a front end side. Further, as illustrated in FIG. 8, the valve housing 517 has a through-hole Ho penetrating in a direction intersecting the axial direction. The through-hole Ho is a hole penetrating through a side wall of the valve housing 517 in the radial direction centered on the central axis C, and is formed to extend in the axial direction as well. The through-hole Ho communicates with the gap in the radial direction between the valve housing 517 and the tube portion 420.

As illustrated in FIG. 6, the spring valve 535 includes the valve body 520 and a spring member 530. As illustrated in FIGS. 7 and 8, the spring member 530 is housed in the valve housing 517. The spring member 530 is housed in the valve housing 517 on a rear end side in the axial direction. The spring member 530 can be made of, for example, metal. In the present embodiment, the spring member 530 is a coil spring. The spring member 530 biases the valve body 520 toward the front end side as illustrated in FIG. 6.

The valve body 520 is mounted in the valve housing 517 in such a way as to be movable in the axial direction. As illustrated in FIGS. 6 and 7, the valve body 520 includes a cylindrical portion 524 and a protruding portion 526. The protruding portion 526 is disposed on an end surface of the cylindrical portion 524, which is a substantially cylindrical member. The cylindrical portion 524 faces an inner surface of the valve housing 517. The valve body 520 can be formed using a thermoplastic resin such as polyethylene or polypropylene. As illustrated in FIG. 7, the protruding portion 526 of the valve body 520 has a tip portion 526A having a circular end surface that can come into contact with the flow path member 710 illustrated in FIG. 2. Note that the tip portion 526A is not limited to having a circular end surface, and may have an end surface of any other shape, such as an elliptical end surface.

The spring valve 535 can be in a “valve-closed state” and a “valve-opened state”. Specifically, the valve body 520 is biased toward the sealing member 510 by the spring member 530. When the cylindrical portion 524 comes into contact with the sealing member 510 by such a bias, the spring valve 535 transitions to the “valve-closed state”. In the “valve-closed state”, the cylindrical portion 524 is in contact with the sealing member 510, thereby closing an opening penetrating through the sealing member 510 in the axial direction. On the other hand, when the flow path member 710 inserted into the tube portion 420 pushes the valve body 520 in a direction opposite to a biasing direction of the spring member 530, and the cylindrical portion 524 is thus separated from the sealing member 510, the spring valve 535 transitions to the “valve-opened state”. In the “valve-opened state”, the cylindrical portion 524 is separated from the sealing member 510, thereby opening the opening penetrating through the sealing member 510 in the axial direction. That is, at the time of replenishing the ink, the spring valve 535 transitions to the “valve-opened state” when the flow path member 710 is inserted into the tube portion 420, and the spring valve 535 transitions to the “valve-closed state” when the flow path member 710 is removed from the tube portion 420.

The components of the liquid container 200 other than the outlet valve unit 500 can be formed using a thermoplastic resin such as polyethylene or polypropylene.

In a liquid container according to the related art, for example, corners of a liquid outlet forming portion and corners of a cap member are more susceptible to damage and breakage during transportation as compared to surfaces such as side surfaces of a main portion. Therefore, it is difficult to reuse the liquid outlet forming portion and the cap member, which can lead to a problem of an environmental load. As in JP-A-2022-129862, the liquid container whose main portion is made of metal is suitable for reuse, but when the liquid outlet forming portion or the cap member has a complex shape, it can be difficult to form the main portion using metal. Therefore, it is conceivable to form the main portion of the liquid container by using plastic or the like. However, in this case, it can be difficult to repeatedly reuse the main portion depending on a strength of the main portion. For this reason, there is a demand for providing a liquid container that can contribute to reducing the environmental load. In the present disclosure, “reuse” means that an empty liquid container is not discarded but is cleaned or the like and refilled with a liquid.

In the liquid container 200 in the present embodiment, the cap member 900 illustrated in FIG. 3 is made of a material that contains a recycled material. As described above, it is sufficient if the cap member 900 includes at least one of the outlet member 550, the first cap member 600, or the second cap member 800. In the present embodiment, the liquid outlet forming portion 400, the first cap member 600, and the second cap member 800 are made of a material that contains a recycled material. In other words, the outlet valve unit 500 of the outlet member 550 is not made of a material that contains a recycled material. The main portion 300 is also not made of a material that contains a recycled material. In contrast, in other embodiments, the outlet valve unit 500 and the main portion 300 may be made of a material that contains a recycled material. In the present disclosure, examples of the “recycled material” include recycled plastic and metal such as aluminum. Here, the recycled plastic is plastic that has been used once and discarded, and then processed through material recycling or chemical recycling to become reusable. Examples of the recycled plastic include recycled polypropylene, recycled polyethylene terephthalate (PET), and recycled polyethylene. The recycled metal is metal that has been used once and discarded, and then processed through recycling to become reusable. According to the aspect, the cap member 900, which is more susceptible to damage during transportation and is less likely to be reused as compared to the main portion 300, is made of a material containing the recycled material, which contributes to reducing the environmental load.

In the liquid container 200 in the present embodiment, the outlet member 550, the first cap member 600, and the second cap member 800 are formed using materials having similar physical properties. More specifically, the liquid outlet forming portion 400, the first cap member 600, and the second cap member 800 are formed using materials having similar physical properties. Here, the “physical property” is, for example, viscosity. Note that the “physical property” is not limited to viscosity. In the present disclosure, for example, viscosities being “similar” means that viscosities of two different materials are within a range of −20% or more and +20% or less at the same temperature of 200° C. or more and at the same pressure. In addition, “the same pressure” includes atmospheric pressure. Further, as for the expression “similar”, a melt flow rate, which is an indicator of flowability of molten plastic, may be used to measure a weight of plastic flowing out for a predetermined time at the same temperature of 200° C. or more and the same pressure for two different materials, and a difference between the two weights may be within a range of −20% to +20%. According to the aspect, the liquid outlet forming portion 400, the first cap member 600, and the second cap member 800 have similar physical properties, and thus, there is no need to separate the liquid outlet forming portion 400, the first cap member 600, and the second cap member 800 at a recovery stage before recycling. Therefore, it is possible to increase efficiency in recycling the members.

In the present embodiment, the liquid outlet forming portion 400, the first cap member 600, and the second cap member 800 are formed by the same molding method. The molding method is, for example, injection molding or blow molding. Normally, even in a case where two components are molded using the same material, when the molding method is different, the two components have different compatible physical properties. For this reason, it is necessary to separate the two components at the recovery stage before recycling. In the present embodiment, the liquid outlet forming portion 400, the first cap member 600, and the second cap member 800 are formed by the same molding method. Therefore, it is not necessary to separate the liquid outlet forming portion 400, the first cap member 600, and the second cap member 800 at the recovery stage before recycling. As a result, it is possible to increase efficiency in recycling the members.

In the present embodiment, a material of the main portion 300 has a higher strength than a material of the cap member 900. The strength is, for example, an impact strength. The impact strength is measured, for example, using the Charpy impact test defined in JIS 7111. When the strength of the material of the main portion 300 is higher than the strength of the material of the cap member 900, the strength of the main portion 300 as a member can be increased as compared to a case where the strength of the material of the main portion 300 is equal to or lower than the strength of the material of the cap member 900. In other words, the main portion 300 is formed to be less susceptible to scratches than the cap member 900. For this reason, the main portion 300 can be reused repeatedly.

According to the first embodiment described above, the liquid container 200 includes the main portion 300 having the first opening 320 and the second opening 340. The cap member 900 of the liquid container 200 is detachably attached to the main portion 300. Furthermore, the cap member 900 is made of a material containing the recycled material. According to the aspect, the main portion 300 can be reused. Furthermore, since the cap member 900, which can be removed from the main portion 300, is made of a material containing the recycled material, the environmental load can be reduced.

### B. Second Embodiment

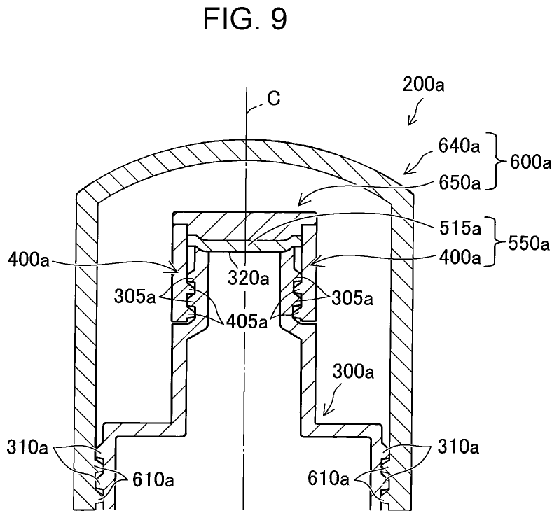

FIG. 9 is a view illustrating a configuration of a liquid container 200a in a second embodiment. In the second embodiment, a front end side configuration of the liquid container 200a including a liquid outlet forming portion 400a and a first cap member 600a is different from that of the first embodiment. Therefore, in FIG. 9, a part of a main portion 300a and a second cap member 800a of the liquid container 200a are omitted.

In the second embodiment, the liquid outlet forming portion 400a is detachably attached to the main portion 300a. A third female thread portion 405a is formed on an inner circumferential surface on a front end side of the liquid outlet forming portion 400a. A third male thread portion 305a is formed on an outer circumferential surface on a front end side of the main portion 300a. The third female thread portion 405a of the liquid outlet forming portion 400a and the third male thread portion 305a of the main portion 300a are threadably engaged.

The liquid container 200a includes a slit valve 515a at one end on a front end side of the main portion 300a. The slit valve 515a is detachably attached to the main portion 300a via the liquid outlet forming portion 400a. In the second embodiment, the slit valve 515a has one slit passing through a central axis C. In the second embodiment, an outlet member 550a includes the liquid outlet forming portion 400a and the slit valve 515a.

The liquid container 200a includes two first cap members 640a and 650a. The liquid container 200a further includes a second cap member 800a (not illustrated) in addition to the first cap members 640a and 650a. In the second embodiment, the first cap member 640a is a cap, and the first cap member 650a is an inner plug. The first cap member 650a is detachably attached to the main portion 300a via the liquid outlet forming portion 400a and the slit valve 515a. The first cap member 650a has a shape covering a first opening 320a via the slit valve 515a. When supplying a liquid from the liquid container 200a to an ink tank (not illustrated), the first cap member 650a is removed from the liquid container 200a, and the liquid is supplied to the ink tank via the slit valve 515a. In the following description, the first cap members 640a and 650a may be collectively referred to as the first cap member 600a.

A fourth female thread portion 610a is formed on an inner circumferential surface on a rear end side of the first cap member 640a of the liquid container 200a, as in the first embodiment. A fourth male thread portion 310a is formed on the outer circumferential surface of the main portion 300a. The fourth female thread portion 610a of the first cap member 640a and the fourth male thread portion 310a of the main portion 300a are threadably engaged.

In the second embodiment, the first cap member 600a, the liquid outlet forming portion 400a, and the second cap member 800a (not illustrated) are made of materials including recycled materials. The first cap member 600a, the liquid outlet forming portion 400a, and the second cap member 800a (not illustrated) are formed using materials having similar physical properties and are formed by the same molding method. Therefore, it is possible to provide the liquid container 200a that can contribute to reducing an environmental load.

### C. Third Embodiment

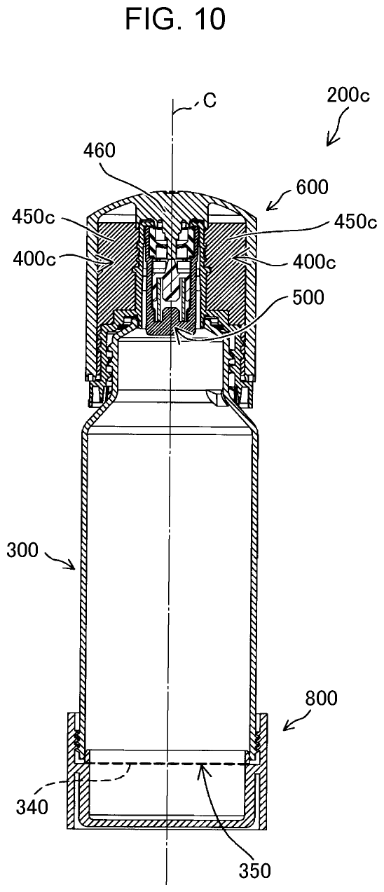

FIG. 10 is a view illustrating a configuration of a liquid container 200c in a third embodiment. FIG. 10 illustrates a cross-sectional view including wall portions 450c corresponding to the wall portions 450 illustrated in FIG. 6. The liquid container 200c in the third embodiment includes a liquid type identification structure 400c disposed around a liquid outlet portion 460, and the liquid type identification structure 400c is configured as a separate body from the outlet member 550 in the first embodiment. The liquid type identification structure 400c includes the wall portions 450c. The wall portion 450c may have a different shape depending on a color of ink contained in the liquid container 200c, or the type of ink, such as dye ink or pigment ink. In the third embodiment, the liquid type identification structure 400c is made of a material that contains a recycled material. The liquid type identification structure 400c is formed by the same molding method using a material having a similar physical property to those of the first cap member 600 and the second cap member 800. Other configurations are the same as those of the first embodiment. According to the aspect, although the liquid type identification structure 400c is a separate body, the liquid type identification structure 400c has a similar physical property to those of the first cap member 600 and the second cap member 800, and thus, separation is not required during recycling. As a result, it is possible to increase efficiency in recycling the members.

### D. Other Embodiments

(D1) In the first embodiment described above, the cap member 900 includes the outlet member 550, the first cap member 600, and the second cap member 800. However, the cap member 900 does not have to include all of the outlet member 550, the first cap member 600, and the second cap member 800. It is sufficient if the cap member 900 includes at least one of the outlet member 550, the first cap member 600, or the second cap member 800. For example, the cap member 900 may include only the outlet member 550 and the first cap member 600.

### E. Other Aspects

The present disclosure is not limited to the embodiments described above, and can be implemented in various configurations without departing from the scope of the present disclosure. For example, the technical features in the above embodiments corresponding to the technical features in each form described in the “Summary” section can be appropriately replaced or combined to solve some or all of the above-described problems or to achieve some or all of the above-described effects. Further, when the technical features are not described as essential in the present specification, the technical features can be deleted as appropriate.

(1) According to a first aspect of the present disclosure, a liquid container that supplies a liquid to a printer is provided. The liquid container includes a main portion that has openings and is configured to contain the liquid, and a cap member that is detachably attached to the main portion and closes the openings in an openable and closable manner, in which the cap member is made of a material that contains a recycled material. According to the aspect, the main portion of the liquid container can be reused. Furthermore, the cap member that can be removed from the main portion is made of the material that contains the recycled material. Therefore, the environmental load can be reduced.

(2) In the above aspect, the openings may include a first opening for supplying the liquid to the printer and a second opening disposed at a position different from the first opening. According to the aspect, it is possible to efficiently store the liquid in the main portion by using the second opening or both the first opening and the second opening. Furthermore, it is possible to efficiently discharge the residual liquid in the main portion and to efficiently clean and dry the main portion by using the second opening or both the first opening and the second opening.

(3) In the above aspect, an opening area of the second opening may be larger than an opening area of the first opening. According to the aspect, by making the opening area of the second opening larger than the opening area of the first opening, it is possible to increase efficiency when storing the liquid in the main portion and when cleaning the inside of the main portion.

(4) In the above aspect, the opening may be the first opening for supplying the liquid to the printer, the cap member may include an outlet member that includes wall portions defining a liquid outlet portion, and a first cap member that covers the liquid outlet portion of the outlet member, the liquid outlet portion may be a liquid outlet for supplying the liquid flowing from the first opening to the printer, and the outlet member and the first cap member may be formed using materials having similar physical properties. According to the aspect, the outlet member and the first cap member have similar physical properties, and thus, separation is not required during recycling. As a result, it is possible to increase efficiency in recycling the members.

(5) In the above aspect, the liquid container may further include a liquid type identification structure disposed around the liquid outlet portion, and the liquid type identification structure may be configured as a separate body from the outlet member. According to the aspect, although the liquid type identification structure is a separate body, the liquid type identification structure has a physical property similar to that of the cap member, and thus, separation is not required during recycling. As a result, it is possible to increase efficiency in recycling the members.

(6) In the above aspect, the openings may include a first opening for supplying the liquid to the printer and a second opening disposed at a position different from the first opening, the cap member may include an outlet member that includes wall portions defining a liquid outlet portion, a first cap member that covers the liquid outlet portion of the outlet member, and a second cap member that closes the second opening in an openable and closable manner, the liquid outlet portion may be a liquid outlet for supplying the liquid flowing from the first opening to the printer, and the outlet member, the first cap member, and the second cap member may be formed using materials having similar physical properties. According to the aspect, the first cap member and the second cap member have similar physical properties, and thus, separation is not required during recycling. As a result, it is possible to increase efficiency in recycling the members.

(7) In the above aspect, a material of the main portion may have a strength higher than that of the material of the cap member. According to the aspect, the main portion can be reused repeatedly.

The present disclosure can be implemented in various forms and can be implemented in forms such as a liquid container manufacturing method, in addition to the above aspects.

What is claimed is:

1. A liquid container that supplies a liquid to a printer, the liquid container comprising:
a main portion that has openings and is configured to contain the liquid; and
a cap member that is detachably attached to the main portion and closes the openings in an openable and closable manner,
wherein the cap member is made of a material that contains a recycled material.

2. The liquid container according to claim 1, wherein the openings include a first opening for supplying the liquid to the printer and a second opening disposed at a position different from the first opening.

3. The liquid container according to claim 2, wherein an opening area of the second opening is larger than an opening area of the first opening.

4. The liquid container according to claim 1, wherein
the opening is a first opening for supplying the liquid to the printer,
the cap member includes an outlet member and a first cap member, the outlet member including wall portions defining a liquid outlet portion, and the first cap member covering the liquid outlet portion of the outlet member,
the liquid outlet portion is a liquid outlet for supplying the liquid flowing from the first opening to the printer, and
the outlet member and the first cap member are formed using materials having similar physical properties.

5. The liquid container according to claim 4, further comprising a liquid type identification structure disposed around the liquid outlet portion,
wherein the liquid type identification structure is configured as a separate body from the outlet member.

6. The liquid container according to claim 1, wherein
the openings include a first opening for supplying the liquid to the printer and a second opening disposed at a position different from the first opening,
the cap member includes an outlet member, a first cap member, and a second cap member, the outlet member including wall portions defining a liquid outlet portion, the first cap member covering the liquid outlet portion of the outlet member, and the second cap member closing the second opening in an openable and closable manner,
the liquid outlet portion is a liquid outlet for supplying the liquid flowing from the first opening to the printer, and
the outlet member, the first cap member, and the second cap member are formed using materials having similar physical properties.

7. The liquid container according to claim 1, wherein a material of the main portion has a strength higher than that of the material of the cap member.
